(19) United States
(12) Patent Application Publication
(10) Pub. No.: US 2018/0121995 A1
(43) Pub. Date: May 3, 2018

(54) SYSTEMS AND METHODS FOR MANAGING THREE DIMENSIONAL MANUFACTURING

(71) Applicant: Capital One Financial Corporation, McLean, VA (US)

(72) Inventors: Luke A. HAMMOCK, Washington, DC (US); Janusz M. NICZYPORUK, Vienna, VA (US); Lawrence DOUGLAS, McLean, VA (US)

(73) Assignee: Capital One Financial Corporation, McLean, VA (US)

(21) Appl. No.: 15/855,372

(22) Filed: Dec. 27, 2017

Related U.S. Application Data
(63) Continuation of application No. 14/594,040, filed on Jan. 9, 2015.
(60) Provisional application No. 61/925,816, filed on Jan. 10, 2014.

(51) Int. Cl. G06Q 30/06

(52) U.S. Cl. CPC G06Q 30/0635

(57) ABSTRACT

The disclosed embodiments include methods and systems for providing financial services for three-dimensional (3D) manufacturing. Consistent with disclosed embodiments, a system may receive a request and payment information from a user for producing a 3D manufacturing product. The system may then transmit the payment information to one or more vendors identified by the request. The system may also provide a registration number associated with the 3D manufacturing product to the user. The one or more vendors may include a manufacturer system and/or a designer system. The designer system may transmit a 3D design file associated with the 3D manufacturing product to the manufacturer after receiving the payment information associated with the 3D manufacturing product.

### CROSS-REFERENCE TO RELATED APPLICATIONS

This application is entitled to and claims the benefit of priority from U.S. Provisional Application No. 61/925,816 filed Jan. 10, 2014, the contents of which are expressly incorporated herein by reference.

### TECHNICAL FIELD

The disclosed embodiments generally relate to 3D manufacturing processes and, in particular, to methods and systems for managing 3D manufacturing services and products.

### BACKGROUND

Three-dimensional (3D) manufacturing, also commonly referred to as 3D printing or additive manufacturing, is a process of making three-dimensional solid objects from a digital file. 3D manufacturing is achieved using additive processes, where an object is created by laying down successive layers of material. Before the manufacturing or printing of a 3D object, a 3D digital design file is usually created using a computer-aided design (CAD) software program. A 3D printer then reads the digital file and forms the 3D object by depositing the materials in layers.

In past years, 3D manufacturing was primarily used by corporate design departments for prototyping new designs at the early stage of product development in commercial design and engineering settings. Along with the advancement of 3D manufacturing technologies, a recent trend has emerged toward low-cost 3D manufacturing services suitable for private users, such as hobbyists, home users, small business owners, etc.

Some stores now offer 3D manufacturing services open to both consumers and industries. Consumers would be able to print their own 3D design at these stores. However, these store-offered services require that consumers be responsible for managing different factors of the 3D manufacturing. For example, consumers have to come up with the 3D digital design and obtain the required raw materials and accessories before performing the 3D manufacturing at the stores. Thus, the current 3D manufacturing service model presents difficulties and disadvantages for the consumers by requiring consumers to separately deal with multiple vendors for different steps of the 3D manufacturing process. An enhanced consumer experience for 3D manufacturing is desired.

### SUMMARY

Disclosed embodiments include methods and systems for providing three-dimensional (3D) manufacturing services.

Consistent with a disclosed embodiment, a system for providing three-dimensional (3D) manufacturing services is provided. The system may include a memory storing instructions, and a processor configured to execute the instructions. When the instructions are executed, the processor is configured to receive a request and payment information from a user for producing a 3D manufacturing product, transmit the payment information to one or more vendors identified by the request, and provide a registration number associated with the 3D manufacturing product to the user. Consistent with another disclosed embodiment, a computer-implemented method for providing three-dimensional (3D) manufacturing services is provided. The method may be performed by at least one processor and comprise receiving a request and payment information from a user for producing a 3D manufacturing product, transmitting the payment information to one or more vendors identified by the request, and providing a registration number associated with the 3D manufacturing product to the user

Consistent with other disclosed embodiments, non-transitory computer-readable storage media may store program instructions, which are executed by at least one processor device and perform any of the methods described herein.

Additional advantages of the disclosed embodiments will be set forth in part in the description which follows, and in part will be apparent from the description, or may be learned by practice of the embodiments. The advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system for providing 3D manufacturing services, consistent with disclosed embodiments;

FIG. 2 illustrates a block diagram of another exemplary system for providing 3D manufacturing services, consistent with disclosed embodiments;

FIG. 3 is a flowchart of an exemplary process for providing 3D manufacturing services, consistent with disclosed embodiments;

FIG. 4 is a flowchart of an exemplary process for manufacturing 3D products, consistent with disclosed embodiments;

FIG. 5 is a flowchart of an exemplary process for providing 3D design files, consistent with disclosed embodiments; and

FIG. 6 is a flowchart of an exemplary process for providing 3D manufacturing supplies, consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

The disclosed embodiments include systems and methods for providing services relating to 3D manufacturing services to improve the operation of computer systems used for manufacturing 3D products and simplify the 3D manufacturing process for customers to create a 3D manufacturing product. For exemplary purposes only, embodiments may be described in connection with users or consumers who desire to create a 3D manufacturing product, 3D manufacturing service providers, manufacturers possessing 3D manufacturing equipment (e.g., 3D printers), 3D manufacturer designers, and material suppliers supplying the raw materials and accessories associated with a 3D manufacturing product (e.g., a product created through 3D manufacturing processes). It is to be understood, however, that disclosed embodiments are not limited to these parties and may, in fact, be applied to any other parties or vendors directly or indirectly involved in 3D manufacturing processes. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, general purpose machines may be specially configured to execute software programs for performing processes consistent with the disclosed embodiments. Alternatively, the disclosed embodiments may utilize an apparatus with specialized hardware or a system configured to execute software programs that perform processes consistent with the disclosed embodiments. Furthermore, although some disclosed embodiments may be implemented by general purpose machines processing instructions, which when executing software instructions to perform one or more processes consistent with the disclosed embodiments function as specialized computing machines, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

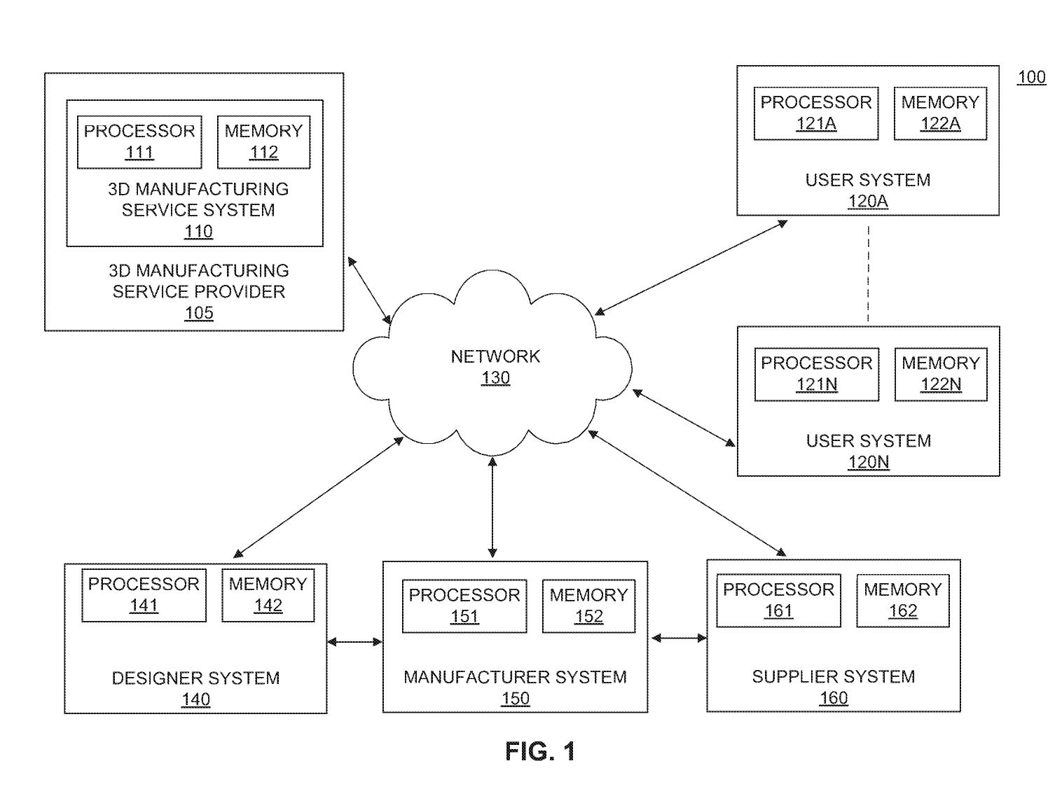

FIG. 1 illustrates an exemplary system 100 consistent with disclosed embodiments. In one aspect, system environment 100 may include a 3D manufacturing service provider 105, one or more user systems 120A-120N, designer system 140, manufacturer system 150, supplier system 160, and network 130.

3D manufacturing service provider 105 may be one or more entities that configure, offer, provide, and/or manage 3D manufacturing services to consumer users. In one aspect, 3D manufacturing service provider 105 may include or be associated with 3D manufacturing service system 110 that may be configured to perform one or more aspects of the disclosed embodiments. In some embodiments, 3D manufacturing service system 110 provides 3D manufacturing service to users. For example, 3D manufacturing service system 110 may provide a variety of manufacturers, 3D designers, or material suppliers that the users can select from to create a 3D manufacturing product.

3D manufacturing service system 110 may be a system associated with one or more entities that configure, offer, provide, and/or manage 3D manufacturing services to consumer users. Consistent with the disclosure, 3D manufacturing service system 110 may provide a service account for providing 3D manufacturing services to one or more users operating user systems 120A-120N. In some embodiments, 3D manufacturing service system 110 may receive and process payments from users (via, e.g., user systems 120A-120N) relating to provided 3D manufacturing services. In some embodiments, 3D manufacturing service system 110 may be configured to obtain, process, and provide payment information, such as information related to purchase of 3D manufacturing products related to one or more user systems 120A-120N, designer system 140, manufacturer system 150, or supplier system 160. In certain embodiments, 3D manufacturing service system 110 may be configured to authenticate payment information provided by the user systems. 3D manufacturer system 110 may authenticate payments information prior to transmitting the authenticated information to designer system 140, manufacturer system 150, and/or supplier system 160.

3D manufacturing service system 110 may include one or more components that perform processes consistent with the disclosed embodiments. For example, 3D manufacturing service system 110 may include one or more computers (e.g., servers, database systems, etc.) configured to execute software instructions programmed to perform aspects of the disclosed embodiments, such as maintaining service accounts, receive payment information for one or more users, transmit the payment information to vendors, etc. Consistent with disclosed embodiments, 3D manufacturing service system 110 may include other components and infrastructure that enable it to perform operations, processes, and services consistent with 3D manufacturing service providers, such as interacting with vendors to make respective 3D manufacturing services or vendors available to the users, etc. Consistent with disclosed embodiments, 3D manufacturing service system 110 may be configured to provide, manage, monitor, and/or assess a prospective 3D product purchase, such as a purchase order from the user systems 120A-120N.

Thus, in certain embodiments, 3D manufacturing service system 110 may include components that perform financial service processes, such as receiving transaction information, processing transaction information, generating and maintaining service accounts (e.g., one or more accounts associated with one or more users), etc. Aspects of the disclosed embodiments may be explained in connection with 3D manufacturing service system 110 performing such financial service processes. However, in other embodiments, system 100 may include a financial service provider system (not shown) that communicates with 3D manufacturing service system 110 (e.g., over network 130 or other communication links) that may be configured to perform such financial service processes on behalf of, or for use by, 3D manufacturing service provider 105 and 3D manufacturing service system 110.

User systems 120A-120N may each include a system associated with one or more users (e.g., customers) that is configured to perform one or more operations consistent with the disclosed embodiments. In one embodiment, associated users may operate user systems 120A-120N to perform one or more such operations. User systems 120A-120N may each include one or more computers (e.g., servers, database systems, etc.) that are configured to execute software instructions programmed to perform aspects of the disclosed embodiments. One of ordinary skill in the art would recognize that user systems 120A-120N may each include components and infrastructure that enable it to perform operations, processes, and services such as processing sales transactions of purchases related to 3D manufacturing products made over the Internet or at POS locations, and communicating with 3D manufacturing service system 110 or other components relating to the transactions. User systems 120A-120N may each be configured to purchase an item, transmit and receive information associated with the purchase transaction, and process and monitor a service account associated with the purchase transaction. User systems 120A-120N may each be located in any location, such as a customer's home, office, kiosk or terminal located at a vendor, etc. Additionally, one skilled in the art will appreciate that any number of user systems 120A-120N may be provided to enable access to 3D manufacturing service system 100. Exemplary user systems 120A-120N include desktop computers, server(s), tablets, mobile phone(s), laptop computers, and any other computing device(s) known to those skilled in the art.

Designer system 140 may include one or more computers configured to receive, process, display, and/or transmit information associated with 3D designs and to perform one or more operations consistent with the disclosed embodiments. Although the following description of certain embodiments may refer to an “individual” designer system, one skilled in the art would appreciate that the same description applies to multiple designer systems that may operate in concert or separate from each other, or in concert with a business entity. Designer system 140 may include components and infrastructure that to perform operations, processes, and services characteristic of merchants, such as providing websites that offer for sale of 3D digital designs, processing sales transactions of purchases, and communicating with 3D manufacturing service system 110 or other components relating to the sales transactions. Consistent with disclosed embodiments, designer system 140 may be configured to execute software instructions that perform processes that enable a business entity (e.g., designer business) to license 3D digital designs to one or more 3D manufacturing service provider 105 through, for example, 3D manufacturing service system 110. Designer system 140 may also be configured to generate and provide 3D designs to a manufacturer business entity for producing 3D objects upon receiving payment for the license, such as through a manufacturer system 150.

Manufacturer system 150 may include one or more computers associated with one or more manufacturers that may be configured to receive, process, display, and transmit information associated with manufacturing of 3D objects. Manufacturer system 150 may include components and infrastructure for performing operations, processes, and services consistent with merchants, such as renting or leasing 3D manufacturing equipment, processing transactions related to manufacturing 3D objects, and communicating with 3D manufacturing service system 110 or other components relating to such transactions. Consistent with disclosed embodiments, manufacturer system 150 may be configured to receive one or more 3D digital designs from designer system 140 and to perform processes associated with delivering completed 3D manufacturing products to users. For example, manufacturer system 150 may perform processes that generate delivery information associated with a manufactured 3D product and provide the delivery information to a user system (e.g., user system 120A) upon receiving confirmation of payment from a user corresponding to the manufacturing transaction.

Supplier system 160 may represent one or more systems associated with one or more supplier business entities that may be configured to receive, process, display, and/or transmit information associated with one or more materials associated with 3D manufacturing products. Supplier system 160 may include components and infrastructure for performing operations, processes, and services consistent with merchants, such as providing websites that offer for sale one or more 3D manufacturing materials and/or accessories, etc. (e.g., supplies), processing sales transactions relating to the purchase of 3D manufacturing supplies, and/or communicating with 3D manufacturing service system 110 or other components of system 100 relating to 3D manufacturing supply transactions. Consistent with disclosed embodiments, supplier system 160 may be configured to perform operations relating 3D manufacturing supply sales with 3D manufacturing service system 110. Supplier system 160 may also perform operations relating to the manufacture, generation, development, and delivery of 3D manufacturing supplies (e.g., materials and/or accessories), including supplies provided to manufacturer system 150 that may be used for manufacturing one or more 3D objects. Supplier system 160 may perform operations relating to the receipt, processing, and confirmation of payments for supplies, such as for example, enabling a respective supplier to deliver upon receiving payment of a purchase of 3D manufacturing supplies.

In some embodiments, one or more system 100 components such as 3D manufacturing service system 110, user systems 120A-120N, designer system 140, manufacturer system 150, and supplier system 160, may include one or more processors (such as processors 111, 121A-121N, 141, 151, or 161) as shown in FIG. 1. The processors may be one or more known processing devices, such as a microprocessor from the Pentium™ family manufactured by Intel™ or the Turion™ family manufactured by AMD™. The processor(s) may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of 3D manufacturing service system 110, user systems 120A-120N, designer system 140, manufacturer system 150, and/or supplier system 160 to execute multiple processes simultaneously. Other types of processor arrangements could be implemented that provide for the capabilities disclosed herein. Moreover, the processors may represent one or more servers or other computing devices that are associated with 3D manufacturing service system 110, user systems 120A-120N, designer system 140, manufacturer system 150, and/or supplier system 160. For instance, the processors may represent a distributed network of processors configured to operate together over a local or wide area network. Alternatively, the processors may be a processing device configured to execute software instructions that receive and send information, instructions, etc. to/from other processing devices associated with 3D manufacturing service provider 105 or other components of system environment 100. In certain aspects, processors 111, 121A-121N, 141, 151, or 161 may be configured to execute software instructions stored in memory to perform one or more processes consistent with disclosed embodiments. Moreover, processors 111, 121A-121N, 141, 151, or 161 may execute one or more programs located remotely from 3D manufacturing service system 110, user systems 120A-120N, designer system 140, manufacturer system 150, or supplier system 160, respectively.

In some embodiments, one or more system 100 components, including 3D manufacturing service system 110, user systems 120A-120N, designer system 140, manufacturer system 150, and supplier system 160, may also include one or more memory devices (such as memories 112, 122A-122N, 142, 152, and 162) as shown in in FIG. 1. The memory devices may store software instructions that are executed by processors 111, 121A-121N, 141, 151, and 161, such as one or more applications, network communication processes, operating system software, software instructions relating to the disclosed embodiments, and any other type of application or software known to be executable by processing devices. The memory devices may include a non-transitory computer readable medium such as, for example, a volatile or non-volatile, magnetic, semiconductor, tape, optical, removable, nonremovable, or other type of storage device or non-transitory computer-readable medium. The memory devices may be two or more memory devices distributed over a local or wide area network, or may be a single memory device. In certain embodiments, the memory devices may include database systems, such as database storage devices, including one or more database processing devices configured to receive instructions to access, process, and send information stored in the storage devices. By way of example, database systems may including Oracle™ databases, Sybase™ databases, or other relational databases or non-relational databases, such as Hadoop sequence files, HBase, or Cassandra.

In some embodiments, 3D manufacturing service system 110, user systems 120A-120N, designer system 140, manufacturer system 150, and/or supplier system 160 may also include one or more additional components (not shown) that provide communications with other components of system environment 100, such as through network 130, or any other suitable communications infrastructure.

Network 130 may be any type of network that facilitates communications and data transfer between components of system environment 100, such as, for example, 3D manufacturing service system 110, user systems 120A-120N, designer system 140, manufacturer system 150, and supplier system 160. Network 130 may be a single network or a combination of networks, and may include a Local Area Network (LAN) and/or a Wide Area Network (WAN) such as the Internet. Further, network 130 may reflect a single type of network or a combination of different types of networks, such as the Internet and public exchange networks for wireline and/or wireless communications. Network 130 may utilize cloud computing technologies that are familiar in the marketplace. Moreover, any part of network 130 may be implemented through traditional infrastructures or channels of trade, to permit operations associated with financial accounts that are performed manually or in-person by the various entities illustrated in FIG. 1. Network 130 is not limited to the above examples and system 100 may implement any type of network that allows the entities (and others not shown) included in FIG. 1 to exchange data and information.

Although FIG. 1 describes a certain number of entities and processing/computing components within system environment 100, any number or combination of components may be implemented without departing from the scope of the disclosed embodiments. For example, manufacturer system 150 may interact with one or more user systems 120A-120N through network 130 or through other types of communication links. In another example, different 3D manufacturing service systems 110 may interact with user systems 120A-120N through network 130. Additionally, 3D manufacturing service system 110, user systems 120A-120N, designer system 140, manufacturer system 150, and supplier system 160 are not mutually exclusive. For example, in one embodiment, 3D manufacturing service system 110 and manufacturer system 150 may be the same entity or affiliated with the same entity. Other combinations are also contemplated by the disclosed embodiments. Moreover, the components of system 100 as described herein are not limited to their discrete descriptions above. Further, where different components of system environment 100 are combined (e.g., 3D manufacturing service system 110 and manufacturer system 150, etc.), the computing and processing devices and software executed by these components may be integrated into a local or distributed system.

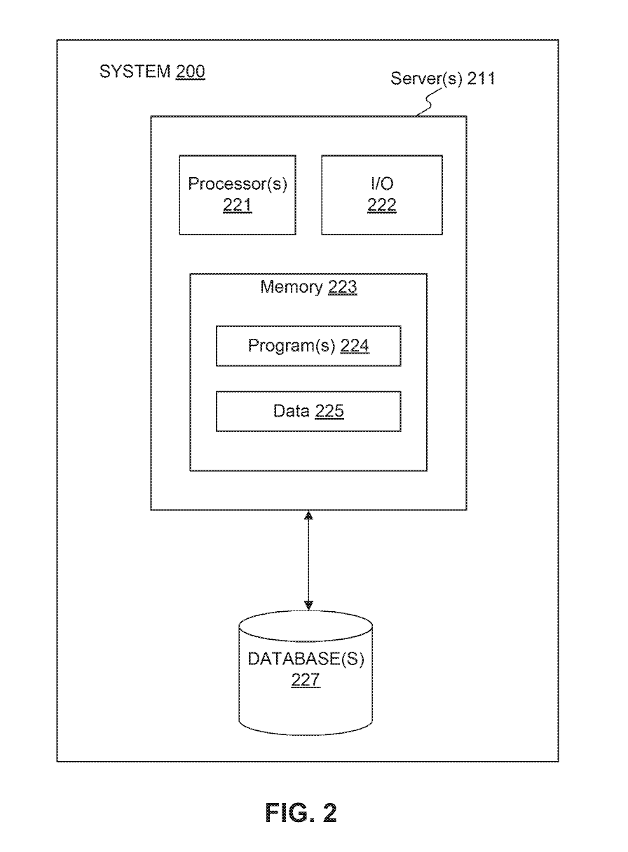

FIG. 2 shows a block diagram of an exemplary system 200 for implementing embodiments consistent with the present disclosure. In certain embodiments, one or more of 3D manufacturing service system 110, user systems 120A-120N, designer system 140, manufacturer system 150, and/or supplier system 160 may include exemplary system 200 to perform one or more operations consistent with the disclosed embodiments. In one embodiment, system 200 may include a server 211 having one or more processors 221, one or more memories 223, and one or more input/output (I/O) devices 222. Alternatively, server 211 may take the form of a mobile computing device, general purpose computer, a mainframe computer, or any combination of these components. According to some embodiments, server 211 may comprise web server(s) or similar computing devices that generate, maintain, and provide web site(s) consistent with disclosed embodiments. Server 211 may be standalone, or it may be part of a subsystem, which may be part of a larger system. For example, server 211 may represent distributed servers that are remotely located and communicate over a network (e.g., network 130) or a dedicated network, such as a LAN. Server 211 may correspond to any server or computing device included in 3D manufacturing service system 110, user systems 120A-120N, designer system 140, manufacturer system 150, and/or supplier system 160.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, 3D manufacturing service system 110, user systems 120A-120N, designer system 140, manufacturer system 150, and/or supplier system 160, may, via server 211, access one or more remote programs that, when executed, perform functions related to certain disclosed embodiments. Memory 223 may also store data 225 that may reflect any type of information in any format that the system may use to perform operations consistent with the disclosed embodiments.

I/O devices 222 may be one or more devices configured to allow data to be received and/or transmitted by server 211. I/O devices 222 may include one or more digital and/or analog communication devices that allow server 211 to communicate with other machines and devices, such as other components of system 100.

Server 211 may also be communicatively connected to one or more database(s) 227. Server 211 may be communicatively connected to database(s) 227 through network 130. Database 227 may include one or more memory devices that store information and are accessed and/or managed through server 211. By way of example, database(s) 227 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 200 may include database 227. Alternatively, database 227 may be located remotely from the system 200. Database 227 may include computing components (e.g., database management system, database server, etc.) configured to receive and process requests for data stored in memory devices of database(s) 227 and to provide data from database 227.

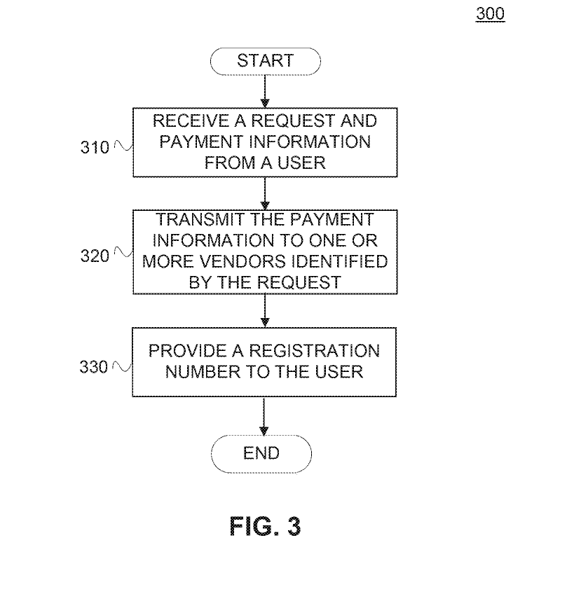

FIG. 3 illustrates a flowchart of an exemplary process 300 for providing 3D manufacturing services, consistent with disclosed embodiments. As an example, one or more steps of process 300 may be performed by 3D manufacturing service system 110, but it is understood that other components may perform such processes to provide 3D manufacturing services to users, such as through manufacturer system 150. In one aspect, 3D manufacturing service system 110 may receive a request from a user, such as a prospective customer operating one of user systems 120A-120N, to create a 3D manufacturing product (Step 310). In some embodiments, the 3D manufacturing service system 110 may receive payment information from the user along with the request. In some embodiments, user system 120 associated with the requesting user may be a stand-alone kiosk or other such unit within a brick and mortar location associated with a business entity, such as a financial service provider (e.g., a bank, etc.). In such embodiments, the associated user system 120 (e.g., kiosk, etc.) may be associated with 3D manufacturing service provider 105. In alternative embodiments, the associated user system 120 may be situated within a location associated with a manufacturer system 150, or at a location affiliated with other merchants, such as at a location affiliated with a designer system 140 or a supplier system 160. 3D manufacturing service system 110 may receive the request from user systems 120A-120N via network 130. In other aspects, 3D manufacturing system 110 may be configured to receive information that has been transformed from other forms of communication from the requesting user, such as where the user provides the request through telephonic or postal communications to a representative of 3D manufacturing service provider associated with system 110. The transformed information may represent the request and payment information from the user.

In some embodiments, the request may include a token or other data that identifies a specific 3D design, manufacturer, and/or supplies (e.g., materials and/or accessories), or other items in connection with the 3D product to be created. The information of the 3D design, manufacturer, and/or supplies may be provided by the 3D manufacturing service provider 105 to one or more users through 3D manufacturing service system 110. In one embodiment, 3D manufacturing service system 110 may generate and provide one or more options that allow the user to select (e.g., a listing provided in a webpage, online portal, or other mechanism). The user may select from a provided listing of available 3D designs, manufacturers, and/or supplies provided by 3D manufacturing service system 110 that may be used to create a 3D product. For example, 3D manufacturing service provider 105 may provide information of available 3D designs, manufacturers, and/or supplies, and their respective provider(s), respective pricing information, etc., on a website or in an electronic catalog for the users to browse and select from. Alternatively, a user may make selections from hard copy documents (e.g., hardcopy catalogs, etc.) and provide the information electronically to 3D manufacturing system 110.

3D manufacturing service system 110 may be configured to request and receive from the user additional information associated with the order. In some embodiments, such additional information may include detailed user information, such as information relating to the user's profession, purpose of the order, location, contact information, or other information associated with the user. In some embodiments, the user may be a prospective customer, an existing customer (e.g., a user who was involved in previous transactions with service provider 105), or a new customer of 3D manufacturing service provider 105. For example, the user operating one of user systems 120A-120N may be an existing customer of 3D manufacturing service provider 105, and the information requested may be sought for purposes of supplementing information already obtained and stored by 3D manufacturing service system 110 (for example, stored in memory 112) associated with the user. In some embodiments, 3D manufacturing service system 110 may be configured to perform a verification process that verifies, authenticates, or the like, the payment information by the user.

In some embodiments, 3D manufacturing service system 110 may perform a user token configuration process. For example, 3D manufacturing service system 110 may generate a token, such as configuring a software object comprising an application programming interface. 3D manufacturing service system 110 may populate the software object with information associated with a prospective customer, such as the user associated with one of the user systems 120A-120N and the information received in the request by the user (e.g., user request from step 310). 3D manufacturing service system 110 may store (or send to be stored) the personalized token (e.g., software object) in memory, which may be local or external to system 110. Additionally, 3D manufacturing service system 110 may perform processes that configure security for the token to protect the privacy and fidelity of the user-provided information.

In one aspect, 3D manufacturing service system 110 may transmit the payment information (which may be verified as described above) and order information relating to the one or more requested items by the user to the vendors identified in the request, such as for example, a 3D designer, manufacturers, suppliers, or any other entity identified by the request (Step 320). In some embodiments, 3D manufacturing service system 110 may transmit the information of the ordered items to server system associated with such entities (e.g., designer system 140, manufacturer system 150, and/or supplier system 160). In one example, 3D manufacturing service system 110 may transmit the order information for the requested one or more items to a system associated with a government entity for purchase of certain government controlled products. 3D manufacturing service system 110 may generate and provide a notification of the order to designer system 140, manufacturer system 150, and/or supplier system 160. In some embodiments, after receiving the payment information and the order information provided by the user in Step 310, the respective one or more vendor system (e.g., system 140, 150, and/or 160) may generate and provide an order indication to the 3D manufacturing service system 110 that the order is accepted or authorized. 3D manufacturing service system 110 may receive the order acceptance information and store it for subsequent processing in a manner consistent with the disclosed embodiments. In one embodiment, the order indication may include information reflecting that the ordered item is backordered or no longer available by the respective one or more vendor(s) associated with the vendor system(s). In some embodiments, the order indication may include information reflecting that additional information is required the respective one or more vendor(s) associated with the vendor system(s) in order to make the determination of whether or not to accept the order.

After receiving an indication from each of the vendors that the ordered items are authorized or accepted, 3D manufacturing service system 110 may provide a registration number to the user confirming that the request is accepted (Step 330). The registration number may provide as a means of certification that the user has properly obtained the license from the owner of the 3D design file in creating the 3D product. Additionally, the registration number may provide as a means for the user to track the status of the requested customized 3D product. For example, the user operating one of user systems 120A-120N may communicate the registration number with the 3D manufacturing service provider 105 to retrieve information associated with the requested 3D product.

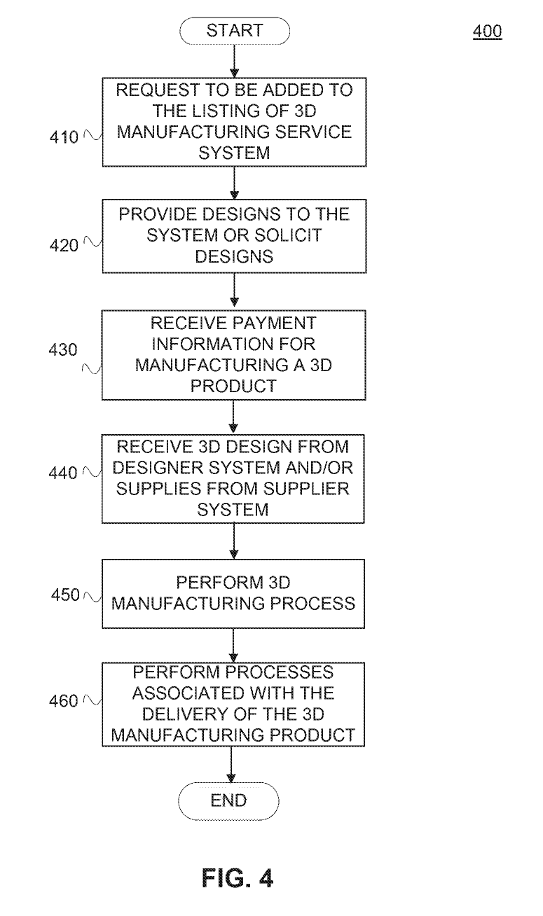

FIG. 4 illustrates an exemplary process 400 for manufacturing 3D products consistent with disclosed embodiments. As an example, one or more steps of process 400 may be performed by manufacturer system 150, but it is understood that other components may perform such processes to perform the 3D manufacturing for the user, such as 3D manufacturing service system 110. Manufacturer system 150 may approach 3D manufacturing service provider 105 and request to be added to the listing of the 3D manufacturing service system 110 (Step 410). Manufacturer system 150 may agree with certain amount of fees charged by the 3D manufacturing service provider 105 in order to be added to the list. After being added to the listing of the 3D manufacturing service system 110, manufacturer system 150 has made its 3D printing or manufacturing services available to the user systems 120A-120N. In other words, user systems 120A-120N will be able to select manufacturer system 150 as the manufacturer for the 3D products to be created through the 3D manufacturing service system 110.

Manufacturer system 150 may provide a set of 3D designs to 3D manufacturing service system 110 such that a user operating one of user systems 120A-120N may select these designs for creating 3D products (Step 420). In some embodiments, manufacturer system 150 may also solicit 3D designs from dedicated designers to enable a broader array of items to be built. In some embodiments, manufacturer system 150 may not have any 3D designs available, and may instead manufacture 3D products using designs purchased and provided by the user. It should be understood that a number of manufacturer systems may exist and provide 3D manufacturing services through 3D manufacturing service provider 105 such that users operating one of user systems 120A-120N may select a preferred manufacturer among the listed manufacturers.

After being added to the listing of 3D manufacturing service system 110, manufacturer system 150 may receive a service order and payment information from 3D manufacturing service system 110 for manufacturing a 3D product (Step 430). The service order may identify the customer name, address, and the specifications for the 3D product. In some embodiments, the service order may identify designer system 140 which may deliver the 3D design to manufacturer system 150 for manufacturing the 3D product. In some embodiments, the service order may also identify supplier system 160 which may deliver 3D manufacturing supplies (e.g., materials and/or accessories) to manufacturer system 150 for manufacturing the 3D product. The payment associated with the 3D product may be made through the automated clearing house (ACH) network, credit card networks, a stored payment account, or any other payment systems. Manufacturer system 150 may perform a verification process that verifies, authenticates, or the like, the payment information provided by 3D manufacturing service system 110.

At Step 440, manufacturer system 150 may receive 3D design from designer system 140 and/or receive supplies (e.g. materials and/or accessories) from supplier system 160. Manufacturer system 150 may receive information of the customer along with the 3D design and/or supplies such that manufacturer system 150 may associate the received 3D design and/or supplies with the appropriate user. After receiving the 3D design and/or supplies, manufacturer system 150 may send a confirmation to the designer system 140 and/or supplier system 160, respectively, acknowledging receipt of the 3D design and/or supplies. In some embodiments, manufacturer system 150 may also send an indication to 3D manufacturing service system 110 after receiving the 3D design and/or supplies, indicating that the 3D design and/or supplies are received and that the 3D product is ready to be printed. In some embodiments, 3D manufacturing service system 110 may subsequently send an indication to user system 120 associated with the requesting user to update the order status.

At Step 450, manufacturer system 150 may manufacture the 3D product using the received 3D design and 3D manufacturing supplies (e.g., materials and/or accessories). In some embodiments, manufacturer system 150 may perform the 3D manufacturing process using the 3D design and/or supplies available at manufacturer system 150. Manufacturer system 150 may use any type of 3D printers for performing the 3D manufacturing process. The 3D printers used for performing the 3D manufacturing process may be either owned, leased, or rented by the manufacturer system 150. There may be different types of 3D printers available at manufacturer system 150 with different price ranges. The advanced 3D printer may be offered for performing the 3D manufacturing process with a relatively higher price, while the basic 3D printer may be offered for performing the 3D manufacturing process with a relatively lower price.

At Step 460, manufacturer system 150 performs processes associated with the delivery of the 3D manufacturing product. For example, manufacturer system 150 may provide delivery information of the finished 3D product to one of user systems 120A-120N. Alternatively, manufacturer system 150 may send an indication to one of user systems 120A-120N, indicating that the 3D product is completed and ready to be picked up by the user. In some embodiments, manufacturer system 150 may also send an indication to 3D manufacturing service system 110 after the 3D product is delivered or picked up, indicating the completeness of the transaction.

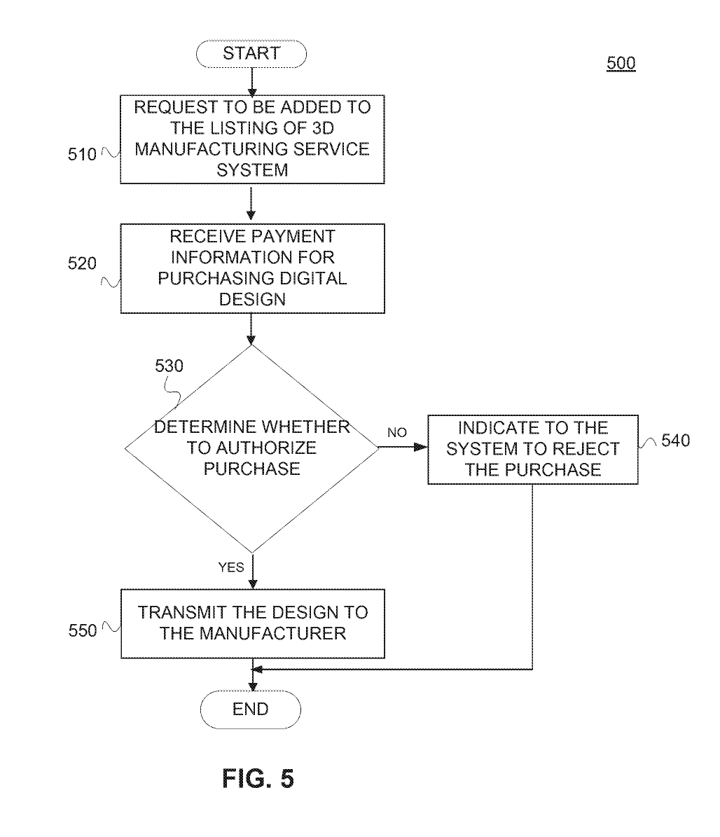

FIG. 5 illustrates is a flowchart of an exemplary process 500 for providing 3D design files, consistent with disclosed embodiments. As an example, one or more steps of process 500 may be performed by designer system 140, but it is understood that other components may perform processes to perform the 3D manufacturing for the user, such as manufacturer system 150 or 3D manufacturing service system 110. Designer system 140 may approach 3D manufacturing service provider 105 and request to be added to the listing of the 3D manufacturing service system 110 (Step 510). Designer system 140 may indicate to 3D manufacturing service provider 105 that certain amount of fees may be charged by 3D manufacturing service provider 105 for being added to the list. After being added to the listing of 3D manufacturing service system 110, designer system 140 has made its 3D design services available to the user systems 120A-120N. In other words, user systems 120A-120N will be able to select the 3D design provided by the designer system 140 for 3D manufacturing through 3D manufacturing service system 110.

Designer system 140 may receive an order and payment information from 3D manufacturing service system 110 for providing, such as licensing or selling, a 3D design to a user operating one of user systems 120A-120N (Step 520). The order may identify the customer name, address, and the ordered 3D design file. In some embodiments, the order may identify manufacturer system 150 which the 3D design will be delivered to for manufacturing the 3D product. The payment associated with the 3D product may be made through the automated clearing house (ACH) network, credit card networks, a stored payment account, or any other payment systems. Designer system 140 may verify the payment information before accepting the order.

Designer system 140 may determine whether to authorize the purchase after receiving the order and payment information (Step 530). In some embodiments, designer system 140 may determine whether to authorize the purchase based on the user information obtained from 3D manufacturing service system 110, such as age of the user, occupation of the user, intended usage of the item, etc. In some embodiments, designer system 140 may request additional information from 3D manufacturing service system 110. For example, additional registration of the user may be required by designer system 140. In some embodiments, a registration code provided by 3D manufacturing service system 110 may be used to associate an online registration flow with the authorization process.

If designer system 140 determines not to authorize the purchase (Step 530: NO), designer system 140 may indicate to 3D manufacturing service system 110 that the order is rejected (Step 540). 3D manufacturing service system 110 may subsequently notify the user that the order is rejected. 3D manufacturing service system 110 may also notify manufacturer system 150 and/or supplier system 160 that the order is cancelled. In some embodiments, designer system 140 may also notify 3D manufacturing service system 110 the reason that the order is rejected. 3D manufacturing service system 110 may store this information and update its system for handling future orders from users with respect to designer system 140.

If designer system 140 determines to authorize the purchase (Step 530: YES), designer system 140 may transmit the 3D design file to the manufacturer or manufacturer system 150 identified in the order (Step 550). Designer system 140 may also transmit the user information and/or order along with the 3D design file to manufacturer system 150 such that manufacturer system 150 can associate the 3D design file with the appropriate user and order. In some embodiments, designer system 140 may indicate to 3D manufacturing service system 110 that the order is accepted after determining to authorize the purchase. In some embodiments, designer system 140 may indicate to 3D manufacturing service system 110 that the order is processed after transmitting the 3D design file to the manufacturer. Designer system 140 may also receive a confirmation from manufacturer system 150 that the 3D design file is received.

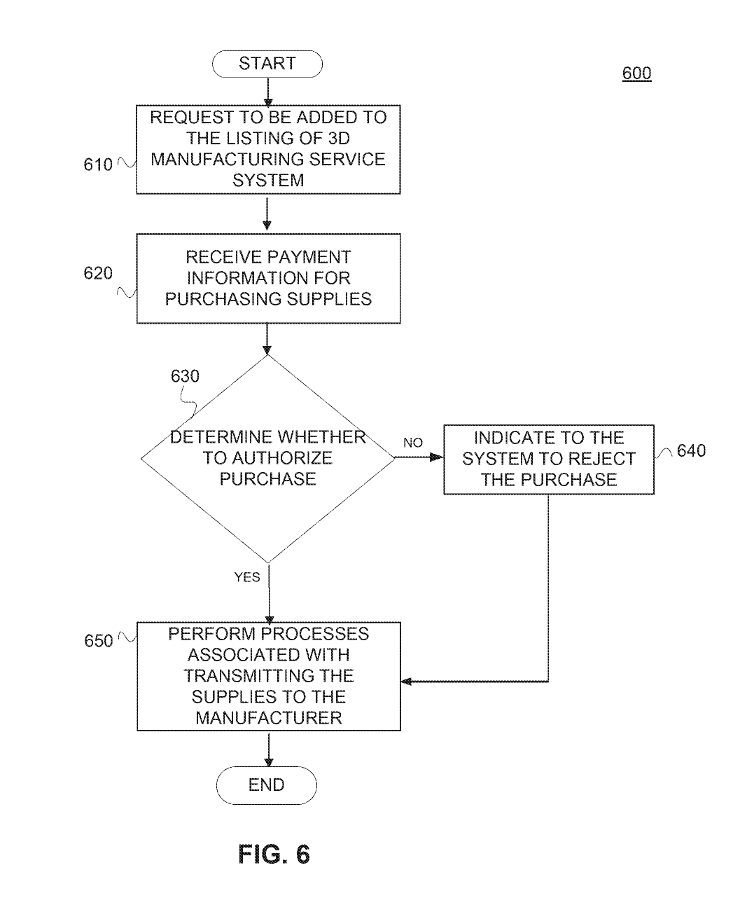

FIG. 6 is a flowchart of an exemplary process 600 for providing 3D manufacturing supplies, consistent with disclosed embodiments. As an example, one or more steps of process 600 may be performed by supplier system 160, but it is understood that other components may perform such processes to perform the 3D manufacturing for the user operating one of user systems 120A-120N, such as manufacturer system 150 or 3D manufacturing service system 110. Supplier system 160 may approach 3D manufacturing service provider 105 and request to be added to the listing of the 3D manufacturing service system 110 (Step 610). Supplier system 160 may indicate to 3D manufacturing service provider 105 that certain amount of fees may be charged by 3D manufacturing service provider 105 for being added to the list. After being added to the listing of 3D manufacturing service system 110, supplier system 160 makes its 3D manufacturing supplies services available to user systems 120A-120N, so that, user systems 120A-120N can select manufacturing supplies (e.g., materials and/or accessories) from the newly-added supplier system 160 for 3D manufacturing through 3D manufacturing service system 110.

After being added to the listing of the 3D manufacturing service system 110, supplier system 160 may receive an order and payment information from 3D manufacturing service system 110 for providing supplies (e.g. materials and/or accessories) to a user (Step 620). The order may identify the customer name, address, and the ordered supplies (e.g. materials and/or accessories). In some embodiments, the order may identify the manufacturer system 150 which supplies may be delivered to for manufacturing the 3D product. The payment associated with the 3D product may be made through the automated clearing house (ACH) network, credit card networks, a stored payment account, or any other payment systems. The supplier system 160 may verify the payment information before accepting the order.

Supplier system 160 may determine whether to authorize the purchase after receiving the order and payment information (Step 630). In some embodiments, supplier system 160 may determine whether to authorize the purchase based on the user information obtained from 3D manufacturing service system 110, such as age of the user, occupation of the user operating one of user systems 120A-120N, intended usage of the item, etc. Supplier system 160 may also determine whether to authorize the purchase based on the availability of the requested items. In some embodiments, supplier system 160 may request additional information from 3D manufacturing service system 110. For example, additional registration of the user may be required by supplier system 160. In some embodiments, a registration code provided by 3D manufacturing service system 110 may be used to associate an online registration flow with the authorization process.

If supplier system 160 determines not to authorize the purchase (Step 630: NO), then supplier system 160 may indicate to 3D manufacturing service system 110 that the order is rejected (Step 640). 3D manufacturing service system 110 may subsequently notify user system 120 associated with the requesting user that the order is rejected. 3D manufacturing service system 110 may also notify manufacturer system 150 and/or designer system 140 that the order is cancelled. In some embodiments, supplier system 160 may also notify 3D manufacturing service system 110 the reason that the order is rejected, for example, the supplies are out of order. 3D manufacturing service system 110 may store this information and update its system for handling future orders from users with respect to supplier system 160.

If supplier system 160 determines to authorize the purchase (Step 630: YES), supplier system 160 may perform processes associated with transmitting the supplies (e.g. materials and/or accessories) to the manufacturer or manufacturer system 150 identified in the order (Step 650). Supplier system 160 may also transmit the user information and/or order along with the 3D design file to manufacturer system 150 such that manufacturer system 150 will be able to associate the supplies with the appropriate user and order. In some embodiments, supplier system 160 may indicate to 3D manufacturing service system 110 that the order is accepted after determining to authorize the purchase. In some embodiments, supplier system 160 may indicate to 3D manufacturing service system 110 that the order is processed after sending the supplies to the manufacturer. Supplier system 160 may also receive a confirmation from manufacturer system 150 that the supplies are received. After receiving the required supplies from supplier system 160, manufacturer system 150 may proceed to perform processes associated with producing the 3D product and deliver it to the user operating one of user systems 120A-120N.

Other features and functionalities of the described embodiments are possible. For example, the processes of FIGS. 3-6 are not limited to the sequences described above. Variations of these sequences, such as the rearrangement, removal and/or addition of other process steps may be implemented without departing from the spirit and scope of the disclosed embodiments.

Additionally, the disclosed embodiments may be applied to different types of 3D manufacturing services. Any 3D manufacturing service provider that provides 3D manufacturing services to customers may employ systems, methods, and articles of manufacture consistent with certain principles related to the disclosed embodiments. In addition, any user of 3D manufacturing services may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of non-transitory computer-readable media, such as secondary storage devices, like hard disks, floppy disks, or CD-ROM, or other forms of RAM or ROM. Accordingly, the disclosed embodiments are not limited to the above described examples, but are instead defined by the appended claims in light of their full scope of equivalents.

1-18. (canceled)

19. A computer-implemented method for manufacturing three-dimensional (3D) products, the method comprising:
requesting, by at least one processor, to be added to a listing of a 3D manufacturing service system;
receiving notification of addition to the 3D manufacturing service system listing;
providing a set of 3D designs to the 3D manufacturing service system;
receiving a 3D product request, including a service order, from the 3D manufacturing service system;
determining a set of required supplies to manufacture the 3D product request based on the service order;
receiving the required supplies;
manufacturing the 3D product request by using the received required supplies; and
transferring the manufactured 3D product to the 3D manufacturing service system.

20. The method of claim 19, where the provided set of 3D designs further includes a subset of 3D designs solicited from a 3D designer system.

21. The method of claim 19, wherein the service order further includes a subset of information from a user.

22. The method of claim 21, wherein the subset of information from the user includes a user-personalized software object token based on user payment information.

23. The method of claim 22, wherein the subset of information from the user further includes a set of 3D selected designs.

24. The method of claim 19, wherein the received service order is for manufacturing a 3D product based on the 3D design.

25. The method of claim 19, wherein the received service order further identifies a designer system or a supplier system.

26. The method of claim 25, wherein the received supplies are from the identified supplier system.

27. The method of claim 19, wherein transferring the manufactured 3D product to the 3D manufacturing service system further includes the 3D manufacturing service system requesting the manufactured 3D product transferred directly to a user.

28. A computer-implemented method for providing three-dimensional (3D) design files, the method comprising:
requesting, by at least one processor, to be added to a listing of a 3D manufacturing service system;
receiving notification of addition to the 3D manufacturing service system listing;
receiving a request for a digital design, including a set of payment information, from the 3D manufacturing service system;
determining whether to authorize the request for the digital design; and
notifying the 3D manufacturing service system of the request if the digital design is authorized.

29. The method of claim 28, wherein the request for the digital design further includes a subset of information from a user.

30. The method of claim 29, wherein the subset of information from the user further includes a user name, an address, an age, an occupation, or an intended use of a requested design, a digital design file, or a registration code.

31. The method of claim 29, wherein the subset of information from the user includes a user-personalized software object token based on user payment information.

32. The method of claim 31, wherein the authorization is based on the user subset of information and the user payment information.

33. The method of claim 32, further comprising notifying the 3D manufacturing service system of the request and a determination not to authorize the request if the request is not authorized.

34. The method of claim 28, further comprising transmitting the authorized request for the digital design to a 3D manufacture.

35. The method of claim 28, wherein the request for the digital design further identifies a manufacture system.

36. A computer-implemented method for providing three-dimensional (3D) manufacturing supplies, the method comprising:
requesting, by at least one processor, to be added to a listing of a 3D manufacturing service system;
receiving notification of addition to the 3D manufacturing service system listing;
receiving a request for a set of 3D supplies, including a set of payment information, from the 3D manufacturing service system;
determining whether to authorize the request for the set of 3D supplies; and
notifying the 3D manufacturing service system if the request for the set of 3D supply is authorized.

37. The method of claim 36, further comprising notifying the 3D manufacturing service system of the request and a determination not to authorize the request if the request is not authorized.

38. The method of claim 36 further comprises transmitting the request for the set of 3D supplies to a 3D manufacture.
